(19) United States
(12) Patent Application Publication
(10) Pub. No.: US 2003/0045342 A1
(43) Pub. Date: Mar. 6, 2003

(54) Method and system for tracking and printing self-selected bingo cards

(76) Inventors: Bradley K. Miller, Tampa, FL (US); Wayne D. Miller, Surrey (CA)

Correspondence Address: Polly D. Heseman, 500 E. Broward Blvd., Suite 1400, Ft. Lauderdale, FL, 33394-3076, US

(21) Appl. No.: 10/230,906

(22) Filed: Aug. 29, 2002

Related U.S. Application Data
(60) Provisional application No. 60/316,041, filed on Aug. 30, 2001.

(51) Int. Cl. A63F 13/00

(52) U.S. Cl. 463/19

(57) ABSTRACT

A method and system for allowing a bingo player to self-select set or sets of bingo numbers for playing a game of bingo using a machine readable bingo number selection form that is read by an input device and stored in the system. The bingo player presents the form and purchases the bingo numbers. The system prints a receipt and bingo game card having the self-selected set or sets of bingo numbers on the receipt and bingo game card. The self-selected bingo numbers may be stored in the system or on portable machine readable media for future play. The system tracks the bingo game while it is being called for quick determination of a winning bingo game. The system provides an accounting of each set of bingo numbers purchased for a particular bingo session.

### CROSS-REFERENCE TO RELATED APPLICATIONS

Provisional Ser. No. 60/316, 041

Filed 8/30/2001

### STATEMENT REGARDING FEDERALLY SPONSORED RESEARCH

Not Applicable

### BACKGROUND OF THE INVENTION

(1) Field of the Invention

The present invention relates to a method and system for recording, tracking and printing bingo cards using a computer software program and related hardware devices for a bingo game, such as the type generally described as “Do It Yourself” or “U Pick Em.” In particular, the invention relates to an integrated high throughput system for recording, tracking and printing self-selected bingo cards, a portable player file containing pre-selected sets of bingo numbers, an optional player sheet, tracking a bingo session in progress, validating a winning bingo card and a detailed accounting report of each bingo session tracked by the system.

The current standard method of self-selecting bingo numbers involves a two-part carbonless bingo game form that is sold to the bingo patron in various formats. One of the most common forms of the “Do It Yourself” game include a form which incorporates all 75 bingo numbers on both copies of the form enabling the bingo patron to then circle with a pen or pencil the self-selected numbers of his or her choice. Another is a form which provides blank spaces with which to manually fill in with a pen or pencil the self-selected numbers between 1 and 75 in any order. Yet another method of self-selecting numbers is a form which provides 24 blank spaces to manually fill-in with a pen or pencil any 5 numbers between 1 and 15 corresponding to the letter B, any 5 numbers between 16 and 30 corresponding to the letter I, any 5 numbers between 31 and 45 corresponding to the letter N, any 5 numbers between 45 and 60 corresponding to the letter G, and any 5 numbers between 61 and 75 corresponding to the letter O. Once the form is filled in with the self-selected numbers, one part of the two-part carbonless form is kept by the bingo player, and the remaining part is placed in a container or containers located in the bingo establishment. Both parts of the two-part carbonless form contain a serial number that is used to match the parts for verification once a “Do It Yourself” bingo game has been called and a potential winner identified.

Some bingo establishments also provide the bingo player with a “Do It Yourself Helper Player Sheet.” This sheet is generally on standard paper size and is used to aid the player in recording the self-selected numbers on a larger scale in order to facilitate the tracking and marking of the numbers as they are announced by the bingo caller.

(2) Description of the Related Art

The related art has shown a number of bingo games using computers to produce and track the game boards and validate the winning bingo game. Illustrative are U.S. Pat. No. 5,007,649 to Richardson, U.S. Pat. No. 5,687,971 to Khaladkar and of particular interest is U.S. Pat. No. 6,398,646 to Wei.

Richardson describes an automated gaming system wherein games cards are downloaded from a library in a base station into an electronic gaming board. Players can create their own cards in advance and input them into a game library. The base station retains a record of downloaded cards. Optionally, a validation code can be downloaded into the game board.

Khaladkar describes a bingo system using a computer to print bingo cards on site and track the sale of the cards. There is a preselected fixed series of cards to provide for a means for tracking the cards in the game. Each card has a serial number associated with it so that it can be retrieved from computer memory. The serial number can be used to verify the winning card. Customers do not select their own numbers.

Wei, et al. describes a method and system for storing preselected numbers for use in games of Bingo. A bingo player preselects numbers which are typed into a computer system. The numbers are stored in player groups in the computer for repetitive play and each set of numbers selected for play from the group is given a control number. Bingo cards are printed with the selected numbers and corresponding control numbers. The control number is used to validate the potentially winning bingo card. However, the system does not provide a way for the general public or casual bingo player who does not have a pre-selected group of numbers stored in the computer to select bingo numbers and receive a printed bingo card. In addition, the method does not provide for a method of inputting large numbers of sets of bingo numbers into the system in a short period of time.

There remains the need for an automated bingo system that can process the input of large quantities of sets of bingo numbers for storing, tracking and printing bingo cards for all types of bingo players, including those players that do not have pre-selected sets of bingo numbers stored in a player file. Additionally, there is a need for storing pre-selected bingo numbers in a player file on portable machine readable media to facilitate the play of the pre-selected set or sets of numbers at multiple bingo establishments without the need for repeating the selection, input and storage process at each establishment. There also remains a need for preventing any additional sets of bingo numbers from being sold once a specific bingo session is closed and a system that can record and track sets of bingo numbers sold during a bingo session. There is also a need for a system for tracking a session of bingo while it is in progress to facilitate quick identification of winning bingo cards. There is an additional need for an integrated accounting system that can provide a detailed audit of each bingo session to the bingo operator.

### SUMMARY OF THE INVENTION

The present invention is related to a method and system for selling, tracking and printing self-selected bingo cards. The method and system of the invention allows bingo players to select bingo numbers for play in a bingo game in a specific bingo session, purchase the selected bingo numbers and quickly receive a printed bingo card. Bingo players pre-select bingo numbers to be played in a bingo game by filling out a machine readable form that is quickly scanned into an input device capable of reading the numbers marked on the form and storing the bingo numbers selected by the bingo player in the system. The bingo player presents the completed form to a computer sales station of the invention. The form is scanned into the system and stored. The system assigns a control number to each set of bingo numbers in put into the system. The system then prints a receipt having: the set or sets of bingo numbers pre-selected printed on the receipt; the control number next to each of the set or sets of bingo number that can be used to verify a winning bingo card; an enlarged bingo game card with the pre-selected set or sets of numbers arranged in horizontal row or rows or a bingo game card with the pre-selected set or sets of numbers arranged in a bingo card style matrix. Optionally, a player sheet having the pre-selected set or sets of bingo numbers can be printed in various formats. A player sheet may have a plurality of bingo card style matrices with either the pre-selected set or sets of bingo numbers arranged in the bingo style matrices or the pre-selected set or sets of bingo numbers arranged in the bingo style matrices with the remaining numbers in the bingo card style matrices filled in by the system. A player sheet may also be arranged in columns each column representing the set of numbers associated with a specific letter in the word B-I-N-G-O.

A bingo player may also store and retrieve favorite bingo numbers either in the system or on portable machine readable media such as a CD-ROM, smart card or the like. The pre-selected set or sets of bingo numbers are marked on the machine readable form. The form is scanned into the system and the pre-selected set or sets of bingo numbers are stored in a player file which is stored either in the system or on portable machine readable media. The player file stored in the system is given a unique identifier for easy retrieval. The pre-selected numbers are retrieved from either the system or the machine readable media and selected for play by a bingo player. The selected set or sets of stored bingo numbers are each assigned a control number and a receipt is printed.

The present invention further relates to a method of playing and tracking a game of bingo which comprises: providing a system for input and output of self-selected bingo cards which comprises: (a) providing at least one computer sales station connected to at least one automated input device and one output device and a software program enabling: (i) accessing the system at the sales station with a password; (ii) selection of a sales clerk for access into the system from a list displayed on an output device; (iii) automatic input of the at least one set of bingo numbers which are selected by a bingo player to be played in at least one selected game of bingo in a specific bingo session; (iv) assignment of a control number for each set of bingo numbers selected for play in the selected bingo game in a specific bingo session; (v) output of a receipt with the control number, the set of bingo numbers which are selected by a bingo player, the invoice number, the price charged for the at least one set of bingo numbers selected and optionally a computer sales station identification number; and (vi) output for verification of a winning set of bingo numbers; (vii) locking the system to prevent additional sales; (b) playing the game of bingo using the at least one set of bingo numbers selected which are selected by a bingo player to be played in the game of bingo in the specific session wherein the bingo player playing the at least one set of bingo numbers announces the invoice number on the potentially winning receipt; (c) providing an output of a re-printed copy of the potentially winning receipt and the potentially winning receipt; (d) displaying the potentially winning receipt and the re-printed copy of the potentially winning receipt for verification of a winning bingo game receipt.

Further, the present invention relates to a method of tracking at least one set of bingo numbers sold in a bingo session in progress which comprises: (a) providing a system for input and output of self-selected bingo cards which comprises: at least one computer sales station connected to at least one automated input device and one output device and a software program enabling: (i) accessing the system with a password; (ii) selection of a sales clerk from a list displayed on an output device; (iii) automatic input of the at least one set of bingo numbers which are selected by a bingo player to be played in at least one selected game of bingo in a specific bingo session; (iv) assignment of a control number for each set of bingo numbers selected for play in the selected bingo game in a specific bingo session; (v) output of a receipt with the control number, the set of bingo numbers which are selected by a bingo player, invoice number, price charged for the at least one set of bingo numbers selected and optionally a computer sales station identification number; (vi) locking the system to prevent additional sales; (b) display of a bingo number drawn by a bingo caller in the bingo session in progress; (c) display of each of the at least one set of bingo numbers sold for the bingo session in progress; (d) display of the invoice number on the receipt of each of the at least one set of bingo numbers sold for a bingo session in progress; (e) display of the bingo numbers drawn by that caller that match individual numbers in the at least one set of bingo numbers sold in the bingo session in progress; (f) display of the winning set of bingo numbers and the control number for the winning set of bingo numbers.

Further still, the present invention relates to a method of verification of a winning bingo game card by providing an output of a bingo game session summary receipt for a specific the date, the total number of invoices sold in the specific bingo session, the total number of sets of bingo numbers sold in the specific bingo session, the first invoice number sold in the specific bingo session, the time the first invoice was sold in the specific bingo session, the last invoice number sold in the specific bingo session and the time the last invoice was sold in the specific bingo session.

Still further, the present invention relates to a method and system of providing an accounting report for a specific bingo session which includes, the date, the time the bingo session was opened, the time the bingo session was locked, the first invoice number assigned in the session, the last invoice number assigned in the session, the time the last invoice number was assigned in the session and optionally the quantity of invoice numbers assigned in a session, invoice numbers returned in a session, the calculated amount of gross sales of receipts sold in a session, the calculated average amount of total receipts sold in a session, the calculated subtotals by individual sales stations, the time the software program locked in the session, the calculated net sales in the session, each of the at least one set of bingo numbers selected in the session, all invoice numbers assigned in the session.

### BRIEF DESCRIPTION OF THE DRAWINGS

FIG. 1 is a schematic representation of a computer sales station (13) of the present invention

FIG. 2 is a schematic representation of a plurality of computer sales stations (13) connected to a common computer server (27) of the present invention.

FIG. 3. is a flow chart showing the method of using the system to purchase a self-selected bingo game card by a bingo player.

FIG. 4. is a flow chart showing the method of using the system to purchase a self-selected bingo cards selected from a player file stored in the system.

FIG. 5. is a flow chart showing the method of using the system to purchase a self-selected bingo cards selected from a player file stored on portable machine readable media.

FIG. 6. is a flow chart showing the method of using the system to play and track a bingo game

FIG. 7. is a copy of a multi-part bingo number selection form.

FIG. 8. is a printout of a receipt showing the self-selected numbers (32) with corresponding control numbers (31) and bingo game board style bingo game card (39).

FIG. 9. is a printout of a receipt showing the self-selected numbers (32) with corresponding control numbers (31) and horizontal line style bingo game card (41).

FIG. 10. is a print out of a player sheet (42) having only the self-selected bingo numbers (32) purchased arranged in a bingo card style matrix.

FIG. 11 is a print out of a player sheet (43) having the self-selected bingo numbers (32) purchased along with system selected bingo numbers arranged in a bingo card style matrix.

FIG. 12 is a print out of a play sheet (44) having the self-selected numbers arranged in columns (45) representing sets of numbers normally associated with the letters in the word B-I-N-G-O.

FIG. 13 is a print out of a detailed report of a bingo session.

FIG. 14 is a bingo game session summary receipt.

### DETAILED DESCRIPTION OF THE INVENTION

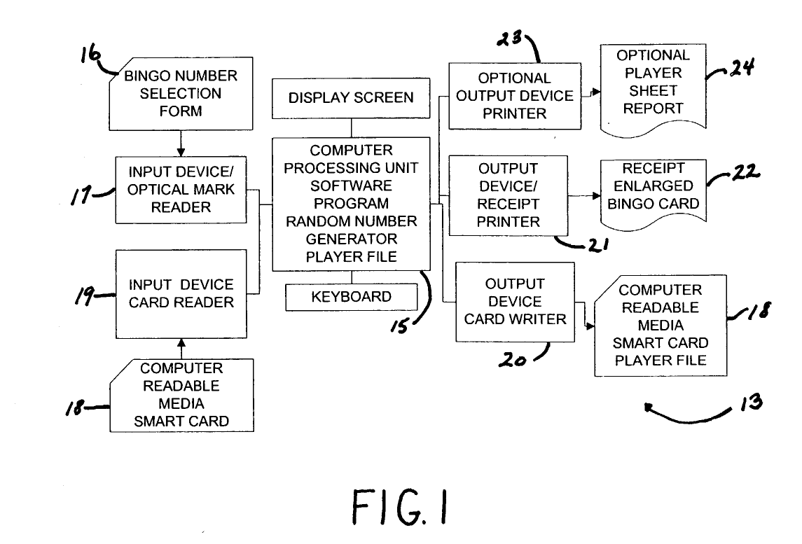

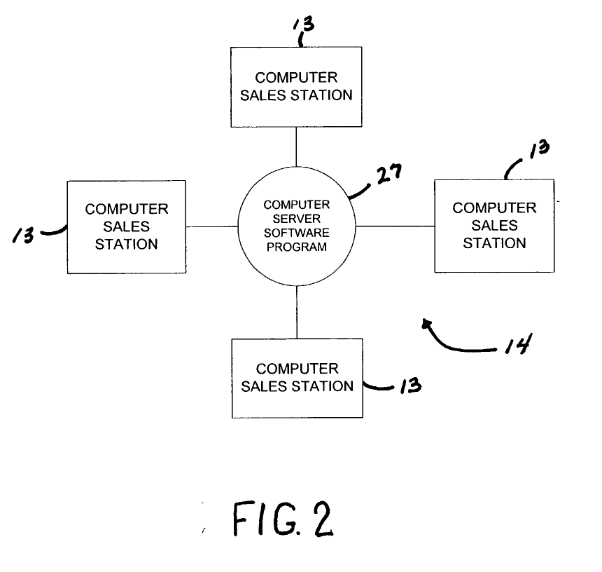

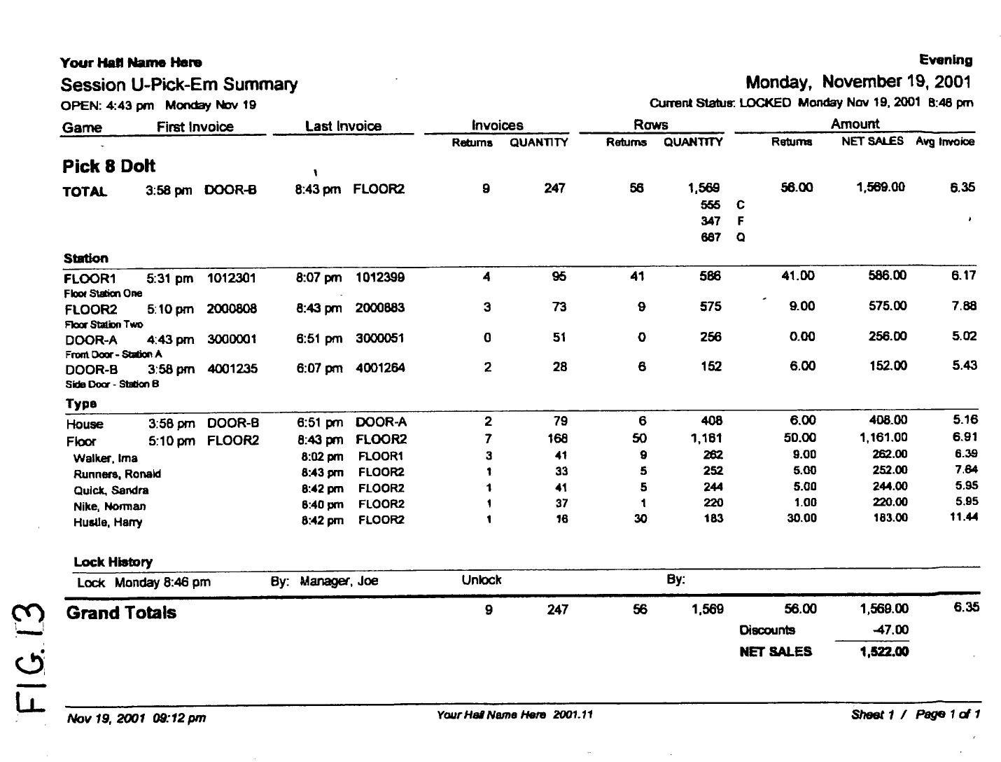

The present invention provides a secure, integrated system (FIG. 1, FIG. 2) that quickly allows the automatic input (17) of a large quantity of sets of bingo numbers selected for play by a bingo player in a bingo game. The system (13, 14) stores the numbers, assigns control numbers (31) to the set or sets of bingo numbers selected to be played and prints a bingo card (39, 41) for use in playing a game of bingo. The system (13, 14) also can provide a detailed report (FIG. 13) of all of the data input in the system for use in verifying winning bingo cards and audit control of an entire bingo session. It is imperative in the bingo industry to provide proper security and audit control methods to insure the integrity of the bingo game for both the bingo operator and the bingo player. This can be accomplished with the use of the novel computer software (15) and hardware applications of the present invention (FIGS. 1 and 2). The present invention provides at least one computer sales station (13). The computer sales station of the present invention includes a computer (15), a software program (15) and at least one automated input device (17) and one output device (22). Multiple computer sales stations may be connected to a common computer or server (FIG. 2) which allows all data input (17, 19) and output (21, 22, 23) from all of the computer sales stations (13) to be compiled. The preferred embodiment constructed according to the principles of the present invention preferably comprises a software program (15) which implements features of the type offered by 516 Holdings, Inc., and can be written using Microsoft Access with Visual Basic software code. The software program (15) is capable of compiling data input the system (FIGS. 1 and 2) and generating various output such as receipts (22), bingo cards (22), player sheets (24) reports (24) and the like. The software is further capable of random number generation. The hardware required to perform the recording, sale, tracking, and printing of the bingo cards (22) for a bingo session comprises a computer, a thermal receipt printer (21) connected to the parallel port of the computer, and an OMR (Optical Mark Reader) (17) connected to the serial port. Exemplary input and output hardware components for use in the invention are an Epson Thermal Receipt Printer Model TM-T88, and a Scantron Corporation Optical Mark Reader Model Wizard.

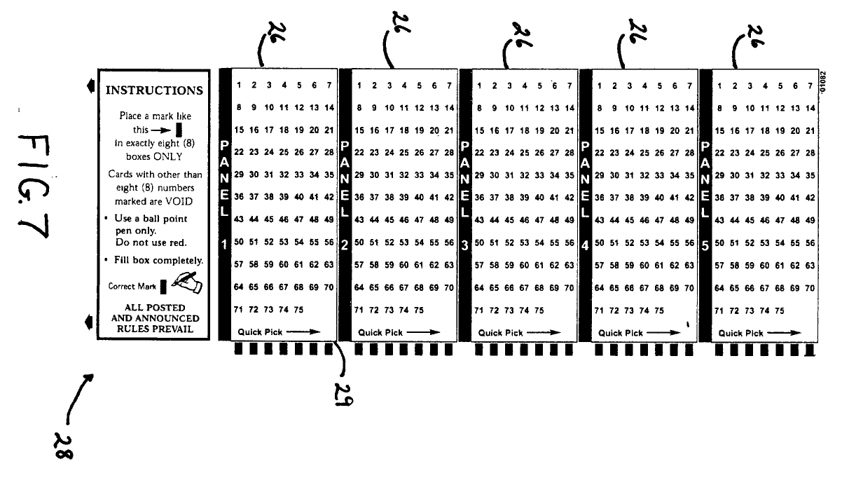

The present invention advantageously replaces the standard two-part carbonless form or the requirement of typing the sets of bingo numbers into a computer. The present invention provides a novel bingo number selection form (FIG. 7) that uses scanning bars. The scanning bars can alternatively be marks that are squares, circles or any other machine readable mark. The bingo number selection form (28) is a machine readable form. A particularly useful form arranged in accordance with the principles of the present invention comprises a multiplicity of parts (28). Each part (26) represents one bingo card. Each part preferably includes the numbers 1 through 75 (26) which correspond to the numbers of each bingo ball that could potentially be drawn in a bingo session. It is understood that other sets of numbers could be made available depending on the type of bingo game to be played. Numbers are marked on at least one part of the form by the bingo player in accordance with the bingo game rules and regulations set forth by each bingo establishment. The markings on the form create scanning bars that can be read quickly by the OMR (17) when the form is scanned. The marked scanning bars correspond to at least one set of bingo numbers to be played in a bingo session. A single set of bingo numbers or multiple sets of bingo numbers are marked on the bingo number selection form each representing a separate bingo card. The bingo number selection form is scanned (28) and automatically input into the system (13) without the need to manually type the sets of bingo numbers into the system. In the preferred embodiment of the invention, the form has five parts (28). Five sets of bingo numbers can be scanned and automatically input into the system at one time. The input device should be capable of inputting multiple sets of bingo numbers at one time but it is understood that a bingo player may at his or her option prefer to select a single set of bingo numbers for a single game. There is also a scanning bar that can be marked if the bingo player wants a “quick pick” (29). If the quick pick bar is marked, the computer software automatically utilizes a random number generator (15) to select the set or sets of bingo numbers for the bingo player. Alternatively, the bingo player picks a set or sets of bingo numbers and has the set or sets of numbers scanned and stored in a player file (15) in a database or on a portable machine readable media (15). The player file and the stored set or sets of bingo numbers can be retrieved and a sets or set of bingo numbers selected for play.

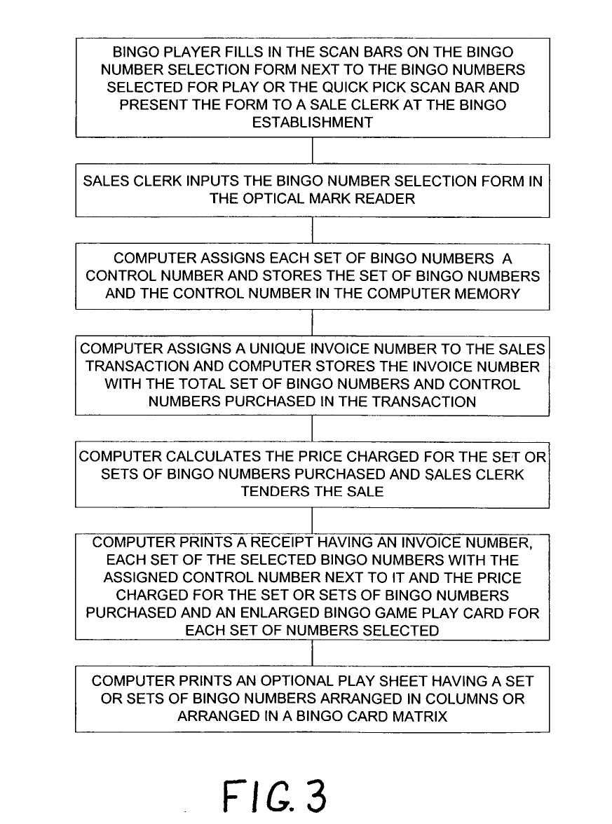

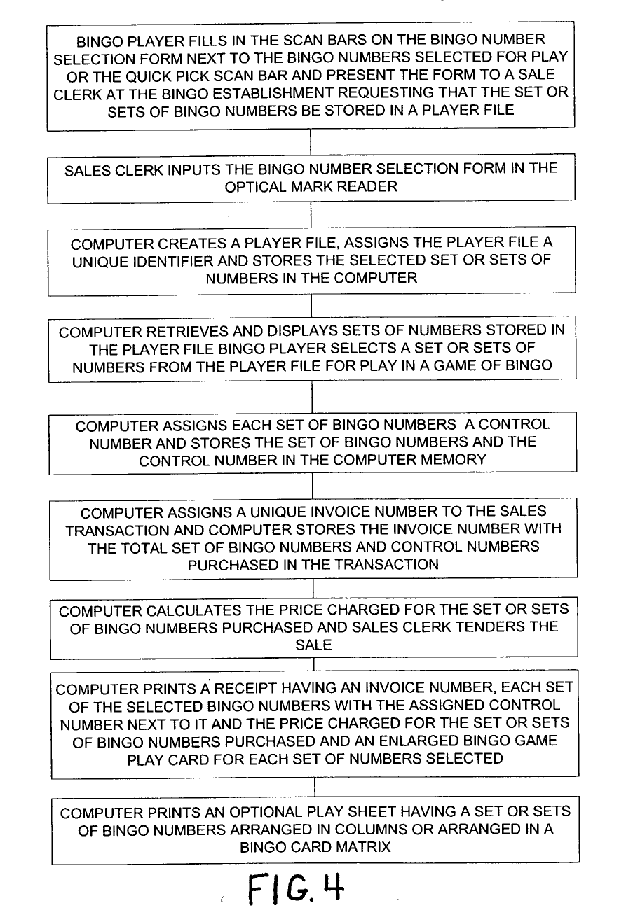

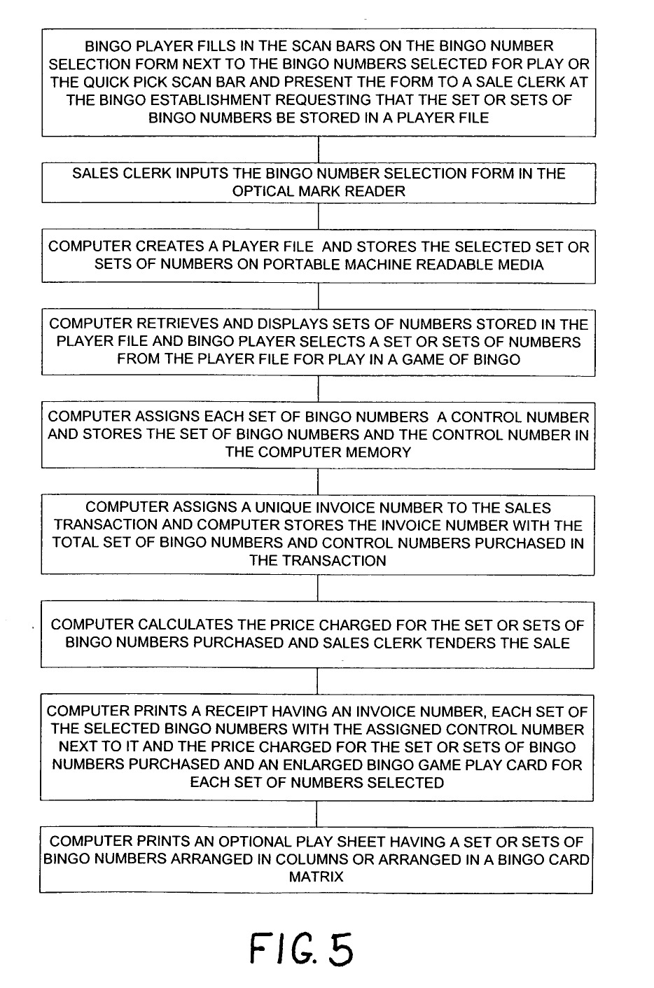

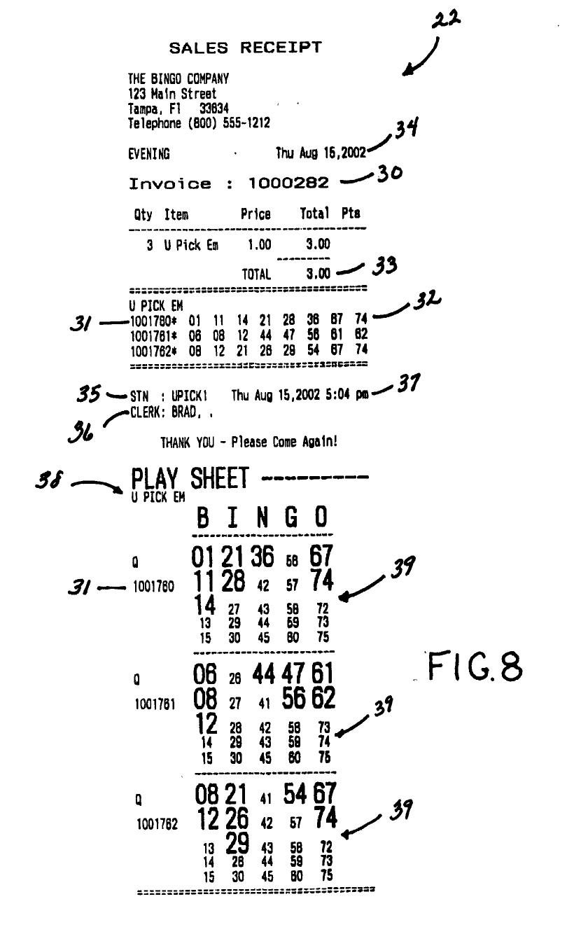

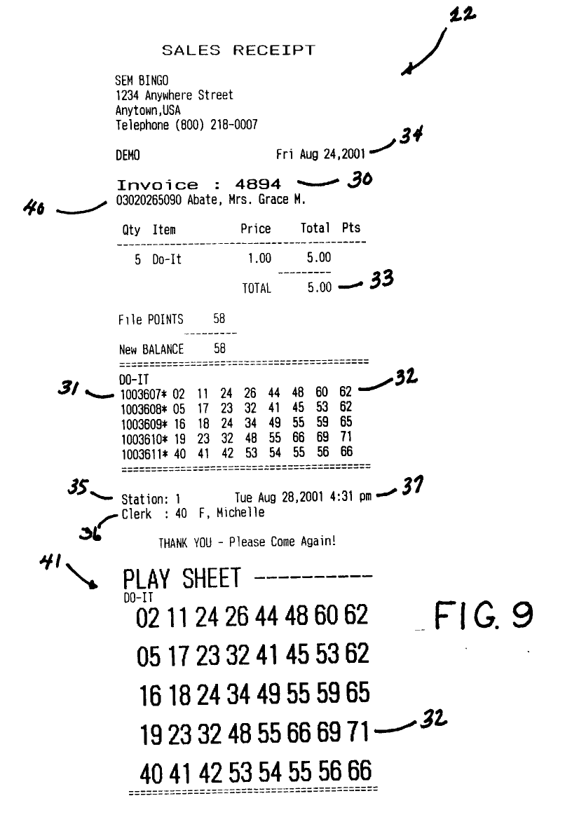

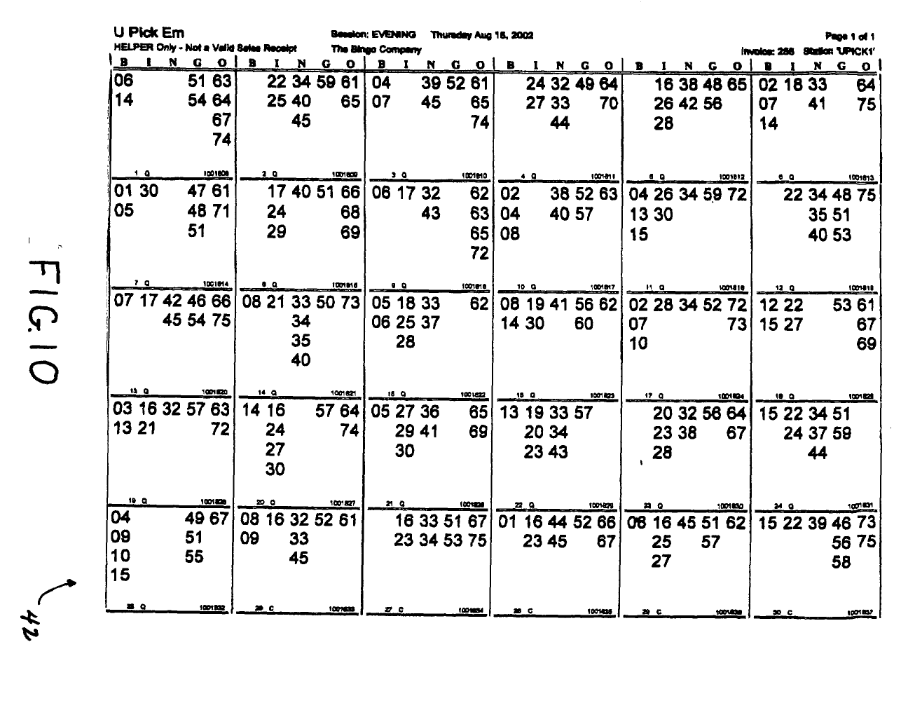

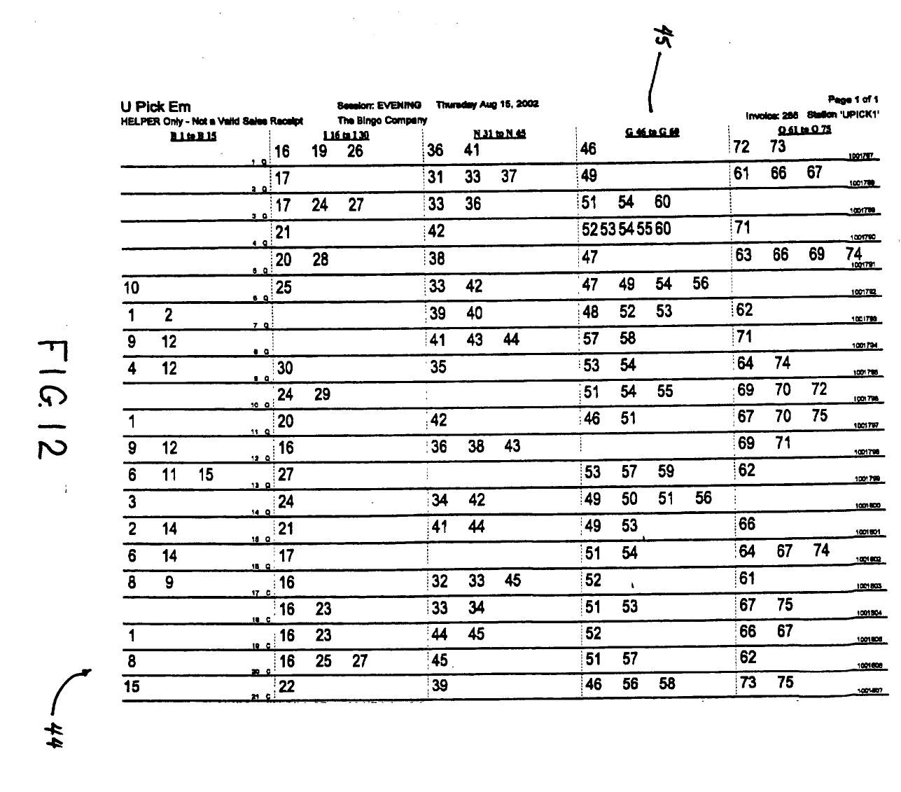

In the preferred embodiment of the invention, the player marks the scanning marks on the bingo number selection form (28) corresponding to the bingo numbers the bingo player wants to select for play in a bingo game (FIGS. 3, 4 and 5). It is understood that the bingo player will mark the quantity of scanning marks in each part (26) of the form (28) depending on the bingo game to be played. A common “U Pick Em” game requires the player to pick 8 bingo numbers between the numbers 1 and 75 (28). However, players may be required to pick more or less than 8 numbers depending on the bingo game to be played. The bingo player takes the completed marked form having at least one set of bingo numbers or the quick pick mark marked by the bingo player to the computer sales station (13). The sales clerk places the form into the OMR scanner hardware (17) to “read” the form. The system (FIGS. 1 and 2) electronically captures and records the numbers corresponding to the scanning marks on the form (28). The selected bingo numbers can be stored in a player file for repetitive selection and play (FIGS. 4 and 5) or a receipt (22) and bingo card (22) can be provided immediately for play (FIG. 3). The system assigns and records an invoice number (30) to the receipt (22). The system assigns and records a control number (31) to each set of bingo numbers (32) marked on the form. The system totals and records the price charged for the set or sets of bingo numbers purchased. A receipt (22) is printed (21) containing the set or sets of numbers (32) selected, the control number or numbers (31) for the set or sets of numbers purchased, the invoice number (30) assigned to the receipt (22) and the price (33) charged for the set or sets of bingo numbers (32) purchased. Additional information may optionally be included on the receipt. The system records and stores, the date (34), a computer sales station identifier (35), a sales clerk identifier (36), and the time (37) of the sale. Any or all of the additional information may be included on the receipt (FIGS. 8 and 9). An optional enlarged bingo card (38, 41) is also attached to the receipt (22) for ease in marking numbers as the bingo balls are drawn and announced. A bingo player may optionally be provided with a player sheet (FIGS. 10, 11 and 12) to help facilitate playing multiple bingo cards in a single bingo session. The player sheet may have the selected sets of numbers arranged and displayed in columns (41) representing the set of numbers (44) normally associated with a specific letter in the word B-I-N-G-O (FIG. 12). Alternatively, the set or sets of numbers may be arranged and displayed in a matrix or matrices each depicting a bingo card. The bingo card matrix can have only the selected have only the selected bingo numbers (42) or can have the selected bingo numbers with the remaining numbers filled in by the system (43).

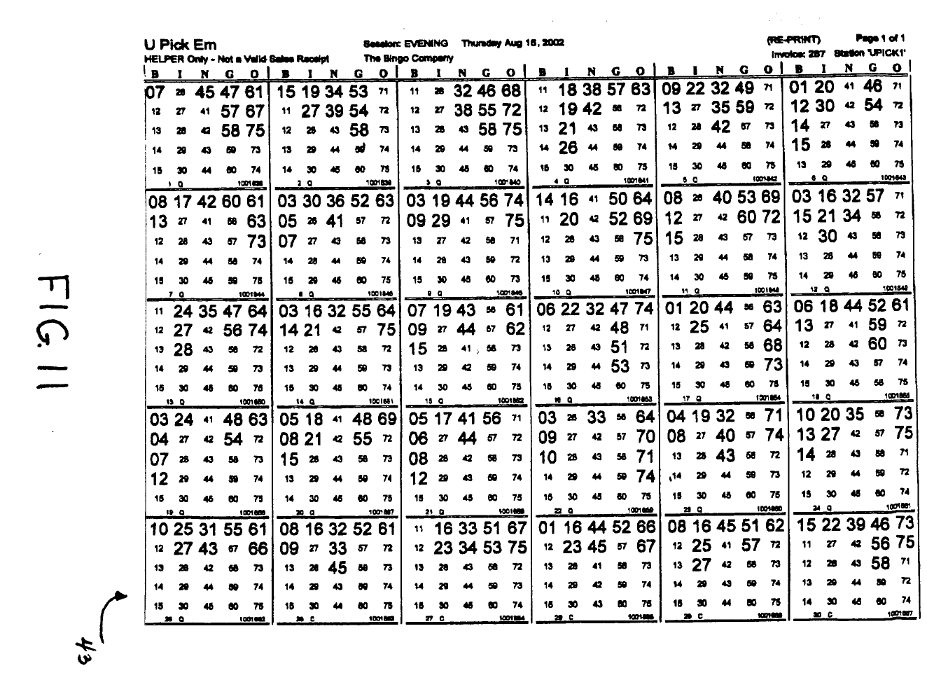

Another feature of the invention allows bingo players to request the sales clerk or bingo operator to store a list of their favorite numbers in the system's database or on portable machine readable media (FIG. 4). The system will store a set or sets of selected bingo numbers for each bingo player. The numbers are preferably entered into the system by means of the OMR hardware (17). The set or sets of bingo numbers are stored in a player file (15) in the system (13) or on portable machine readable media (18). In the preferred embodiment of the invention, the machine readable media is either a smart card or a credit card size CD-ROM. Of course, it is understood that any input/output device or media which can facilitate the automatic input and output of stored data is suitable, such as uploading the numbers from a handheld computer, a personal digital assistant, a computer network such as the Internet, a magnetic strip on a plastic card, and the like. If the player file (15) is stored in the database of the system (13), a player identifier (40) will be assigned to the player file (15) for easy retrieval of the set or sets of numbers in the player file (15). If the player file (18) is stored on portable machine readable media (18), it is not necessary to assign a player identifier. The numbers stored on a portable machine readable media (18) allows the bingo player to carry and retrieve the player file with him or her to any bingo establishment utilizing the present invention. A receipt tape detailing the stored favorites is printed and provided to the bingo player for future reference. The set or sets of numbers on file may also be edited, replaced, added to, and moved at the bingo player's request at any time. Once the set or sets of numbers are stored, the sales clerk retrieves and displays the set or sets of bingo numbers on a monitor or display screen. The bingo player selects and purchases the set or sets of bingo numbers for purchase and play without the need for completing a new bingo number selection form. The system assigns and records an invoice number (30) to the receipt (22). The system assigns and records a control number (31) to each set of bingo numbers selected from the player file. The system totals and records the price (33) charged for the set or sets of bingo numbers purchased. A receipt is printed containing the set or sets of numbers selected (32), the control number (31) or numbers for the set or sets of numbers purchase, the invoice number (30) and the price (33) charged for the set or sets of bingo numbers (32) purchased. Additional information may optionally be included on the receipt (22). The system records and stores, the date (34), the computer sales station identifier (35), the sales clerk identifier (36), and the time (37) of the sale. Any or all of the additional information may be included on the receipt (22). An optional enlarged bingo card (FIGS. 8 and 9) is also attached to the receipt (22) for ease in marking numbers as the bingo balls are drawn and announced. The optional enlarged bingo card can have each set of bingo numbers arranged in a horizontal line (41) or in a bingo card style matrix (38). A bingo player may optionally be provided with a player sheet to help facilitate playing multiple bingo cards in a single bingo session. The player sheet (FIG. 12) may have the selected sets of numbers arranged and displayed in columns (45) each column representing the set of numbers normally associated with a specific letter in the word B-I-N-G-O. Alternatively, the set or sets of numbers may be arranged and displayed in a matrix or matrices (FIGS. 10 and 11) each depicting a bingo card. The matrix or matrices can have the selected set or sets of bingo numbers (42) or the system can additionally include numbers in the remaining bingo card spaces (43).

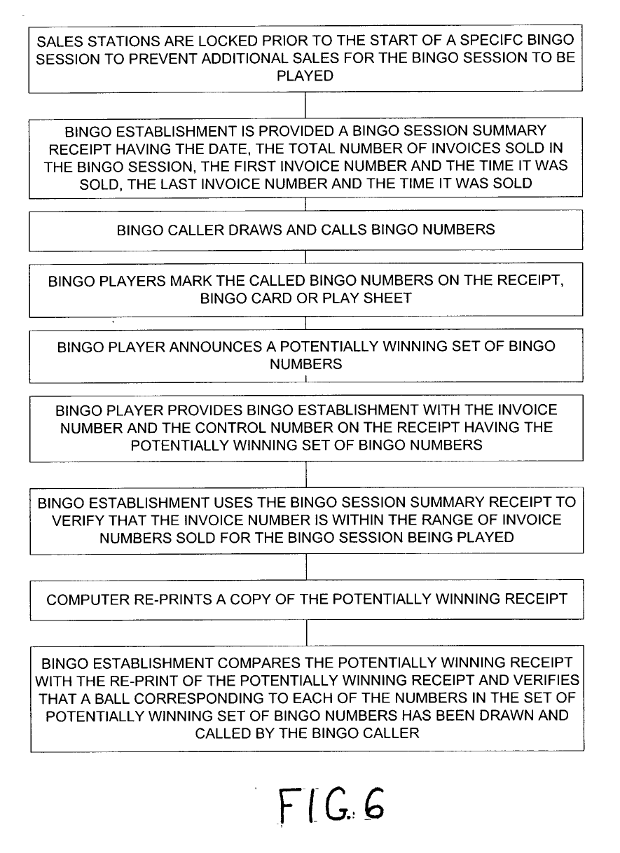

The method and system of the present invention allows the self-selection by a bingo player of a set or sets bingo numbers for play in a bingo game, automatic printing of a bingo card corresponding to the selected set or sets of bingo numbers and tracking of the set or sets of bingo numbers sold for a specific session (FIG. 6). By way of example, a bingo game session is scheduled for play and the sales station is opened. All functions within the system are password protected to ensure audit control. At the point of opening the session, all pertinent data is can be accessed at the sales station, including all bingo games available for play in the specific session, all customer data and customer tracking control numbers on file, and a list of available sales clerks authorized to operate the sales stations. Each sales clerk selects his or her name from a selection screen at the computer sales station. Preferably access into the system from the selection screen is password protected for audit control purposes. Using the sales screen, the sales clerk can process a sale in which the bingo player selects a set or sets of numbers on the form marked in accordance with each individual bingo operation's rules and regulations. The player marks the form and presents the form to the sales clerk for scanning. Alternatively, the sales clerk can process a sale in which the bingo player selects a “quick pick” option on the form and presents the form to the cashier for scanning. In yet another alternative, the sales clerk can process a sale in which the bingo player with a set or sets of numbers in a player file. The sales clerk retrieves the stored set or sets of numbers and the bingo player selects the set or sets of numbers from a database within the system or uploaded from a computer readable media without presenting a marked form. Prior to the beginning a specific bingo session, the station is “locked” by a bingo staff member with proper security code clearance to perform the locked function. The locked function prevents additional sales at all sales stations, and ensures that no sets of numbers can win that have not been entered in the system after the specific game sale session is closed.

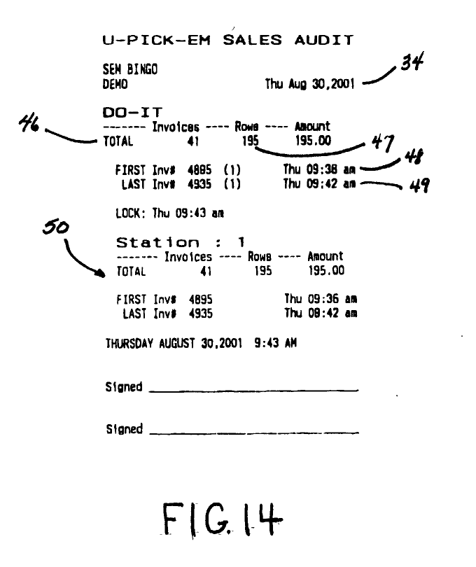

The system of the invention optionally provide a bingo session summary receipt (FIG. 14) for the convenience of the bingo operator that includes the date (34), the total number of invoices sold in session (46), the total number of sets of bingos sold in a session (47), the first invoice number and the time it was sold (48), the last invoice number and time it was sold (49). The receipt includes a subtotal of the information by computer sales station (50). The receipt (FIG. 14) allows the bingo operator to know the set of invoice numbers that are valid for a particular bingo session prior to the bingo caller beginning calling numbers for a particular bingo session. The game proceeds with the bingo caller drawing and calling the bingo numbers. Players mark the called numbers on the bingo card or optional player sheet. Once a bingo player announces that he or she has marked all the selected numbers in the pre-determined number of bingo balls called, the verification process begins. Every transaction from every sales station is logged in the system database and made available for validating a potentially winning ticket. The bingo player's winning control number is announced and a copy of the receipt is re-printed at any of the sales station. Preferably, this feature is password protected for security. Using the bingo session summary receipt, bingo establishment personnel can quickly verify that the receipt is within the range of invoice numbers eligible to win in the bingo session in which it was played. The potentially winning original receipt and the re-printed copy of the receipt are presented to the bingo caller or other bingo establishment personnel for validation. The potentially winning original receipt and the re-printed copy of the potentially winning receipt may be placed on an overhead camera and displayed in full view of the other bingo patrons. The bingo establishment personnel verifies that all numbers marked have actually been drawn and announced by the caller. The prize is awarded only if the bingo card is validated.

Additional methods of verification are maintained within the software program of the system of the present invention. Hall operators are able to track all active invoice and control numbers for every set of selected numbers issued for a specific bingo game session while the bingo session is in progress (FIG. 6). As numbers are drawn and announced by the caller, the numbers are entered into the system and displayed. The system compiles, updates and displays the data as it is entered into the system. As the bingo game progresses, the system displays the numbers drawn that are in play, the number of sets of bingo numbers sold, the invoice number on the receipt on which each set of numbers appear, the control number next to each set of bingo numbers sold, and the number of matches in each set of selected bingo numbers. The number of matches in each set of selected bingo numbers is updated and displayed each time a new bingo number is drawn by the caller and entered into the system. Once a bingo player announces that he or she has a winning bingo card, the caller knows immediately if that game card is indeed a winner by identifying the control number assigned to the set of winning numbers or the invoice number on the receipt.

The system of the invention further can provide an accounting report (FIG. 13) for a specific bingo session which includes, the date, the time the bingo session was opened, the time the bingo session was locked, the first invoice number assigned, the last invoice number assigned, the time the last invoice number was assigned, quantity of invoice numbers assigned, invoice numbers returned, the calculated amount of gross sales of receipts, the calculated average amount of total receipts, the calculated subtotals by individual sales stations, the time the software program locked the bingo session, the calculated net sales, each at least one set of bingo numbers selected, each invoice numbers assigned. It is understood that the pertinent data can be manipulated to provide various other reports, including daily, monthly or annual totals of data and the like.

It is intended that the foregoing description be only illustrative of the present invention and that the present invention be limited only by the hereinafter appended claims.

What is claimed is:

1. A method and system for selling, tracking and printing self-selected bingo cards which comprises:
(a) at least one computer sales station, an automated input device and output device;
(b) at least one set of bingo numbers, each at least one set of bingo numbers representing one bingo play card selected by a bingo player; and
(c) a software program enabling:
(i) automatic input of the at least one set of bingo numbers which are selected by a bingo player to be played in at least one selected game of bingo in a specific bingo session;
(ii) assignment and recording of a control number for each set of bingo numbers selected for play in the selected bingo game in a specific bingo session; and
(iii) output of a receipt with the control number, the set of bingo numbers which are selected by a bingo player, the invoice number, the price charged for the at least one set of bingo numbers selected, and optionally a computer sales station identifier; and
(iv) output for verification of a winning set of bingo numbers.

2. The method of claim 1, wherein the automated input device is an optical mark reader (OMR), the output device is a printer and the system further comprises: a form capable of being marked by a bingo player with scanning bars corresponding to at least one set of bingo numbers selected by the bingo player for playing a bingo game wherein
(i) the form is scanned by the OMR and the at least one set of bingo numbers on the form marked by the bingo player is automatically input into the system.

3. The method of claim 1, wherein the software program further enables: storage of the at least one set of bingo numbers selected by a bingo player as a player file, retrieval of the player file, and selection from the player file by the player of at least one of the sets of bingo numbers in the player file for play in a selected bingo game in a specific bingo session.

4. The method of claim 3, wherein the software program further enables assignment of a unique player identifier to the player and retrieval of the player file using the player identifier.

5. The method of claim 3, wherein the player file is stored on and retrieved from a portable machine readable medium.

6. The method of claim 5, wherein the portable machine readable medium is a personal digital assistant, a smart card, a CD-ROM or a magnetic strip on a plastic card.

7. The method of claim 1, wherein the receipt optionally includes, a date, a sales station identifier, a sales clerk identifier and a time of sale.

8. The method of claim 1, wherein the software program further enables access to the system with a password and access prevention with a locked function.

9. The method of claim 1, wherein the at least one computer sales station comprises a multiplicity of computer sales stations each connected to a common computer.

10. The method of claim 1, wherein the software program further enables an output of a player sheet with the at least one set of bingo numbers arranged and displayed in columns each column representing the set of numbers associated with a specific letter in the word bingo.

11. The method of claim 1, wherein the software program further enables an output of a player sheet with each of the at least one set of bingo numbers arranged and displayed in a matrix depicting a bingo card.

12. The method of claim 1, wherein the software program further enables a random number generator and the at least one set of bingo numbers are randomly selected by the software program.

13. The method of claim 1, wherein the software further enables the output of a bingo game session summary receipt for a specific bingo session comprising the date, the total number of invoices sold in the specific bingo session, the total number of sets of bingo numbers sold in the specific bingo session, the first invoice number sold in the specific bingo session, the time the first invoice was sold in the specific bingo session, the last invoice number sold in the specific bingo session and the time the last invoice was sold in the specific bingo session.

14. A method of playing and tracking a game of bingo which comprises the steps of:
(a) providing a system for input and output of self-selected bingo cards which comprises: at least one computer sales station connected to at least one automated input device and one output device and a software program enabling:
(i) accessing the system at the sales station with a password;
(ii) selection of a sales clerk for access into the system from a list displayed on an output device;
(iii) automatic input of the at least one set of bingo numbers which are selected by a bingo player to be played in at least one selected game of bingo in a specific bingo session;
(iv) assignment of a control number for each set of bingo numbers selected for play in the selected bingo game in a specific bingo session;
(v) output of a receipt with the control number, the set of bingo numbers which are selected by a bingo player, the invoice number, the price charged for the at least one set of bingo numbers selected and optionally a computer sales station identification number; and
(vi) output for verification of a winning set of bingo numbers;
(vii) locking the system to prevent additional sales;
(b) playing the game of bingo using the at least one set of bingo numbers selected which are selected by a bingo player to be played in the game of bingo in the specific session wherein the bingo player playing the at least one set of bingo numbers announces the invoice number on the potentially winning receipt;
(c) providing an output of a re-printed copy of the potentially winning receipt and the potentially winning receipt;
(d) displaying the potentially winning receipt and the re-printed copy of the potentially winning receipt for verification of a winning bingo game receipt.

15. The method of claim 14, wherein in (d) the potentially winning receipt and the re-printed copy of the potentially winning receipt are displayed on a screen in the bingo establishment in full view of other bingo patrons.

16. The method of claim 14, wherein the automated input device is an optical mark reader (OMR), the output device is a printer and the system further comprises: a form capable of being marked by a bingo player with scanning bars corresponding to at least one set of bingo numbers selected by the bingo player for playing a bingo game wherein (i) the form is scanned by the OMR and the at least one set of bingo numbers on the form marked by the bingo player is automatically input into the system.

17. The method of claim 15, wherein the software program further enables: storage of the at least one set of bingo numbers selected by a bingo player as a player file and selection from the player file by the player of at least one of the sets of bingo numbers in the player file for play in a selected bingo game in a specific bingo session.

18. The method of claim 17, wherein the software program further enables assignment of a unique player identifier to the player and retrieval of the player file using the player identifier.

19. The method of claim 17, wherein the player file is stored on a portable machine readable medium.

20. The method of claim 19, wherein the portable machine readable medium is a personal digital assistant, a smart card or a magnetic strip on a plastic card.

21. The method of claim 14, wherein the receipt optionally includes, a price for the at least one set of bingo numbers selected by the bingo player, a date, a sales station identifier, a sales clerk identifier and a time of sale.

22. The method of claim 14, wherein the at least one computer sales station comprises a multiplicity of computer sales stations each connected to a common computer.

23. The method of claim 14, wherein the software further enables the output of a bingo game session summary receipt for a specific bingo session comprising the date, the total number of invoices sold in the specific bingo session, the total number of sets of bingo numbers sold in the specific bingo session, the first invoice number sold in the specific bingo session, the time the first invoice was sold in the specific bingo session, the last invoice number sold in the specific bingo session and the time the last invoice was sold in the specific bingo session.

24. A method of tracking at least one set of bingo numbers sold in a bingo session in progress which comprises:
(a) providing a system for input and output of self-selected bingo cards which comprises: at least one computer sales station connected to at least one automated input device and one output device and a software program enabling:
(i) accessing the system with a password;
(ii) selection of a sales clerk from a list displayed on an output device;
(iii) automatic input of the at least one set of bingo numbers which are selected by a bingo player to be played in at least one selected game of bingo in a specific bingo session;
(v) assignment of a control number for each set of bingo numbers selected for play in the selected bingo game in a specific bingo session;
(vi) output of a receipt with the control number, the set of bingo numbers which are selected by a bingo player, invoice number, price charged for the at least one set of bingo numbers selected and optionally a computer sales station identification number;
(vii) locking the system to prevent additional sales;
(b) display of a bingo number drawn by a bingo caller in the bingo session in progress;
(c) display of each of the at least one set of bingo numbers sold for the bingo session in progress;
(d) display of the invoice number on the receipt of each of the at least one set of bingo numbers sold for a bingo session in progress;
(e) display of the bingo numbers drawn by the caller that match individual numbers in the at least one set of bingo numbers sold in the bingo session in progress;
(f) display of the winning set of bingo numbers and the control number for the winning set of bingo numbers.

25. The method of claim 24, wherein the at least one computer sales station comprises a multiplicity of computer sales stations each connected to a common computer.

26. The method of claim 24, wherein the software further enables the output of a bingo game session summary receipt for a specific bingo session comprising the date, the total number of invoices sold in the specific bingo session, the total number of sets of bingo numbers sold in the specific bingo session, the first invoice number sold in the specific bingo session, the time the first invoice was sold in the specific bingo session, the last invoice number sold in the specific bingo session and the time the last invoice was sold in the specific bingo session.

27. The method of claim 1, wherein the software program further enables an output of an accounting report for a specific bingo session which includes, the date, the time the bingo session was opened, the time the bingo session was locked, the first invoice number assigned in the session, the last invoice number assigned in the session, the time the last invoice number was assigned in the session and optionally the quantity of invoice numbers assigned in a session, invoice numbers returned in a session, the calculated amount of gross sales of receipts sold in a session, the calculated average amount of total receipts sold in a session, the calculated subtotals by individual sales stations, the time the software program locked in the session, the calculated net sales in the session, each of the at least one set of bingo numbers selected in the session, all invoice numbers assigned in the session.
